(19) United States
(12) Patent Application Publication
(10) Pub. No.: US 2025/0100947 A1
(43) Pub. Date: Mar. 27, 2025

(54) NITROUS OXIDE INHIBITOR

(71) Applicant: His Majesty the King in Right of New Zealand Acting Through the Ministry For Primary Industries, Wellington (NZ)

(72) Inventors: Paul Charles Dummere Newton, Palmerston North (NZ); Coby Jane Hoogendoorn, Palmerston North (NZ); Phillip Warren Theobald, Palmerston North (NZ); Willora Mudiyanselage Saman Deepal Bowatte, Palmerston North (NZ)

(73) Assignee: His Majesty the King in Right of New Zealand Acting Through the Ministry For Primary Industries, Wellington (NZ)

(21) Appl. No.: 18/723,297

(22) PCT Filed: Dec. 22, 2022
(86) PCT No.: PCT/NZ2022/050179

§ 371 Date: Jun. 21, 2024

(30) Foreign Application Priority Data
Dec. 23, 2021 (AU) 2021904230

(51) Int. Cl. C05G 3/90; C05G 5/20; C05G 5/30; C09K 17/14

(52) U.S. Cl. CPC C05G 3/90; C05G 5/20; C05G 5/30; C09K 17/14

(57) ABSTRACT

Disclosed is a bicyclic 1H-benzo[d]imidazol-2-yl ester compound that may be useful for reducing nitrous oxide (N₂O) emissions and/or reducing nitrate (NO₃) leaching, from a nitrogen containing substrate, e.g., from soil. Also disclosed are a liquid agricultural composition and a coated fertiliser composition comprising a bicyclic 1H-benzo[d]imidazol-2-yl ester compound, and a method of reducing N₂O emissions and/or NO₃ leaching from a nitrogen containing substrate.

### TECHNICAL FIELD

The present invention relates to the use of a bicyclic 1H-benzo[d]imidazol-2-yl ester compound for reducing nitrous oxide emissions and/or nitrate leaching. The present invention also relates to compositions comprising a bicyclic 1H-benzo[d]imidazol-2-yl ester compound and associated methods for reducing nitrous oxide emissions and/or nitrate leaching.

### BACKGROUND ART

Agriculture is a major source of nitrogen release to the environment. Nitrogen in soil may be converted to nitrous oxide (N₂O), a powerful greenhouse gas, and subsequently released into the atmosphere. Nitrogen in soil may also be converted to nitrate (NO₃), which can leach into underground or nearby water supplies. Nitrogen released into the atmosphere and water through these pathways has detrimental environmental effects. Additionally, these losses present a problem to the agricultural industry both in losses of productivity, through inefficient use of nitrogen, and negative public perceptions of agriculture as a polluter.

Nitrous oxide emissions from pasture soil occur during the microbially mediated processes of nitrification and denitrification of soil nitrogen. A major source of soil nitrogen is urine deposited by livestock during grazing. Between 30-50% of agricultural emissions of N₂O comes from the excreta of domestic animals, particularly from animal urine. The majority of urine is deposited in the process of grazing. Animals harvest nitrogen from across a grassland, but then deposit it in small discrete urine patches of high N load. These urine patches produce conditions favouring N₂O production by soil microbes.

Another major source of soil nitrogen is nitrogenous fertilisers. Such fertilisers are applied to soil or pasture to provide a source of nitrogen for plants. Nitrogenous fertilisers include organic fertilisers, such as manure and compost, and manufactured fertilisers, such as urea and ammonium nitrate.

One method for reducing the production of N₂O and the leaching of NO₃ is to apply a chemical inhibitor to soil containing a source of nitrogen. Known chemical inhibitors include dicyandiamide (DCD), dimethylphenylpiperazinium (DMPP) and nitrapyrin. However, these chemicals are not consistently effective. Furthermore, some known chemical inhibitors, such as DCD, have been withdrawn from the market because of undesirable residues.

Accordingly, it is an object of the present invention to go some way to avoiding the above disadvantages; and/or to at least provide the public with a useful choice.

Other objects of the invention may become apparent from the following description which is given by way of example only.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date.

### SUMMARY OF THE INVENTION

In a first aspect, the present invention relates to use of a compound of formula (I):

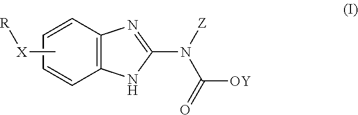

wherein R is C₁₋₅ alkyl, C₂₋₅ alkenyl or C₃₋₅ cycloalkyl;
X is CH₂, CO, S, SO or SO₂;
Z is H, C₁₋₅ alkyl, C₂₋₅ alkenyl or C₃₋₅ cycloalkyl; and
Y is C₁₋₅ alkyl, C₂₋₅ alkenyl or C₃₋₅ cycloalkyl;
for reducing N₂O emissions and/or NO₃ leaching from a nitrogen containing substrate.

Preferably, the nitrogen containing substrate is a pasture or an arable soil.

In some embodiments, the compound is a compound of formula (Ia):

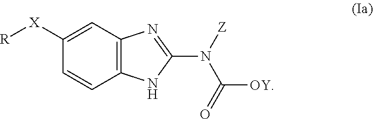

In some embodiments, R is C₁₋₅ alkyl; X is S, SO or SO₂; Z is H; and Y is C₁₋₅ alkyl. In some embodiments, R is propyl; X is S, SO or SO₂; Z is H; and Y is methyl. Preferably, wherein R is C₁₋₅ alkyl; X is SO; Z is H; and Y is C₁₋₅ alkyl. More preferably, the compound is albendazole sulfoxide.

In a further aspect, the present invention provides a liquid agricultural composition for reducing N₂O emissions and/or NO₃ leaching from a nitrogen containing substrate, the composition comprising:
a) a compound of formula (I):

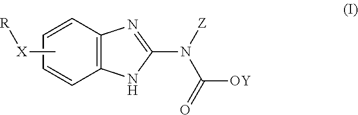

wherein R is C₁₋₅ alkyl, C₂₋₅ alkenyl or C₃₋₅ cycloalkyl;
X is CH₂, CO, S, SO or SO₂;
Z is H, C₁₋₅ alkyl, C₂₋₅ alkenyl or C₃₋₅ cycloalkyl; and
Y is C₁₋₅ alkyl, C₂₋₅ alkenyl or C₃₋₅ cycloalkyl; and
b) a liquid agriculturally acceptable carrier.

In some embodiments, the compound is a compound of formula (Ia):

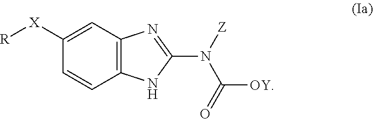

In some embodiments, R is C₁₋₅ alkyl; X is S, SO or SO₂; Z is H; and Y is C₁₋₅ alkyl. In some embodiments, R is propyl; X is S, SO or SO₂; Z is H; and Y is methyl. Preferably, R is C₁₋₅ alkyl; X is SO; Z is H; and Y is C₁₋₅ alkyl. More preferably, the compound is albendazole sulfoxide.

In some embodiments, the liquid agriculturally acceptable carrier comprises a solvent and a weak acid. Preferably, the solvent is water.

In some embodiments, the weak acid has a pH between about 2 and about 7, or between about 3 and about 6. In some embodiments, the weak acid is an acid having a pH between about 3 and about 6. In some embodiments, the weak acid is an organic acid. Preferably, the organic acid is carboxylic acid. More preferably, the carboxylic acid is formic acid. In some embodiments, the weak acid is a mineral acid. Preferably, the mineral acid is boric acid.

In some embodiments, the composition comprises the compound in a concentration of about 5.3 to about 18 mg L⁻¹.

Preferably, the composition comprises albendazole sulfoxide, formic acid and water.

Preferably, the nitrogen containing substrate is a pasture or an arable soil.

In a yet further aspect, the present invention provides a method of reducing N₂O emissions and/or NO₃ leaching from a nitrogen containing substrate, the method comprising applying a composition of the invention to the substrate, wherein the composition is applied to the substrate before, during or after the substrate is contacted with a nitrogen source selected from the group consisting of an animal waste, a nitrogenous fertiliser and a combination thereof.

Preferably, the nitrogen containing substrate is a pasture or an arable soil.

In some embodiments, the composition is applied to substantially all of the pasture or arable soil.

In some embodiments, the composition is spot applied to areas of the pasture or arable soil. Preferably, the composition is spot applied to areas of high nitrogen load in the pasture or arable soil.

In some embodiments, the composition is applied with a manual sprayer or an automated sprayer system.

In some embodiments, the animal waste is urine from a grazing animal.

In some embodiments, the composition is applied to the substrate at a rate of above 0 kg N ha⁻¹ to about 1200 kg Nha⁻¹.

In a still further aspect, the present invention provides a coated fertiliser composition comprising a nitrogenous fertiliser at least partially coated with a compound of formula (I):

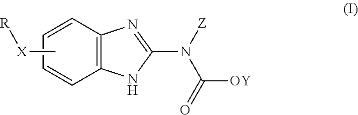

wherein R is C₁₋₅ alkyl, C₂₋₅ alkenyl or C₃₋₅ cycloalkyl;
X is CH₂, CO, S, SO or SO₂;
Z is H, C₁₋₅ alkyl, C₂₋₅ alkenyl or C₃₋₅ cycloalkyl; and
Y is C₁₋₅ alkyl, C₂₋₅ alkenyl or C₃₋₅ cycloalkyl.

In another aspect, the present invention relates to use of a compound of formula (I):

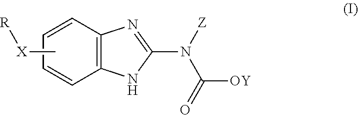

wherein R is C₁₋₅ alkyl, C₂₋₅ alkenyl or C₃₋₅ cycloalkyl;
X is CH₂, CO, S, SO or SO₂;
Z is H, C₁₋₅ alkyl, C₂₋₅ alkenyl or C₃₋₅ cycloalkyl; and
Y is C₁₋₅ alkyl, C₂₋₅ alkenyl or C₃₋₅ cycloalkyl
in the manufacture of an agricultural composition for reducing N₂O emissions and/or
NO₃ leaching from a nitrogen containing substrate.

Preferably, the nitrogen containing substrate is a pasture or an arable soil.

In still another aspect, the present invention provides a method of manufacturing an agricultural composition comprising dissolving a compound of formula (I):

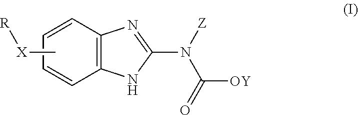

wherein R is C₁₋₅ alkyl, C₂₋₅ alkenyl or C₃₋₅ cycloalkyl;
X is CH₂, CO, S, SO or SO₂;
Z is H, C₁₋₅ alkyl, C₂₋₅ alkenyl or C₃₋₅ cycloalkyl; and
Y is C₁₋₅ alkyl, C₂₋₅ alkenyl or C₃₋₅ cycloalkyl;
in a liquid agricultural acceptable carrier.

In yet another aspect, the present invention provides a concentrated liquid composition comprising a compound of formula (I):

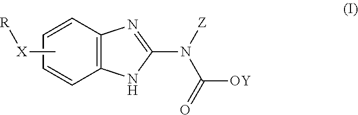

wherein R is C₁₋₅ alkyl, C₂₋₅ alkenyl or C₃₋₅ cycloalkyl;
X is CH₂, CO, S, SO or SO₂;
Z is H, C₁₋₅ alkyl, C₂₋₅ alkenyl or C₃₋₅ cycloalkyl; and
Y is C₁₋₅ alkyl, C₂₋₅ alkenyl or C₃₋₅ cycloalkyl; and
a liquid agricultural acceptable carrier.

In some embodiments, X is S, SO or SO₂. In some embodiments, X is SO₂. In some embodiments, R is C₁₋₅ alkyl. In some embodiments, R is C₂₋₄ alkyl. In some embodiments, R is propyl. In some embodiments, Z is H. In some embodiments, Y is C₁₋₅ alkyl. In some embodiments, Y is C₁₋₃ alkyl. In some embodiments, Y is methyl or ethyl.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

In addition, where features or aspects of the invention are described in terms of Markush groups, those persons skilled in the art will appreciate that the invention is also thereby described in terms of any individual member or subgroup of members of the Markush group.

As used herein “(s)” following a noun means the plural and/or singular forms of the noun.

As used herein the term “and/or” means “and” or “or” or both.

The term “alkyl” as used herein refers to a straight or branched chain saturated aliphatic hydrocarbon. Preferably, the alkyl group is a C₁₋₅alkyl group, i.e. an alkyl group having 1 to 5 carbon atoms. In some embodiments, the C₁₋₅ alkyl group is a straight chain aliphatic hydrocarbon, such as methyl, ethyl, propyl, butyl or pentyl. In some embodiments, the C₁₋₅ alkyl group is a branched chain saturated aliphatic hydrocarbon, such as isopropyl or isobutyl.

The term “alkenyl” as used herein refers to straight or branched chain unsaturated aliphatic hydrocarbon having one or more carbon-carbon double bonds. Preferably, the alkenyl group is a C₂₋₅alkenyl group, i.e. an alkenyl group having 2 to 5 carbon atoms. In some embodiments, the C₂₋₅ alkenyl group is a straight chain aliphatic hydrocarbon, such as ethenyl, propenyl, butenyl or pentenyl. In some embodiments, the C₂₋₅ alkenyl group is a branched chain saturated aliphatic hydrocarbon, such as isopropenyl or isobutenyl.

The term “cycloalkyl” as used herein refers to a cyclic saturated aliphatic hydrocarbon. Preferably, the cycloalkyl group is a C₃₋₅ cycloalkyl group, i.e. an cycloalkyl group having 3 to 5 carbon atoms. In some embodiments, the C₃₋₅ cycloalkyl group is cyclopropyl, cyclobutyl or cyclopentyl.

The term “nitrogen containing substrate” as used herein refers to a bare pasture or arable soil, as well as to productive pasture or arable soil that is covered in plant material such as arable crops or grass.

The term “soil environment” as used herein refers to bare soil or to a plant covered arable or pasture soil.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

Although the present invention is broadly as defined above, those persons skilled in the art will appreciate that the invention is not limited thereto and that the invention also includes embodiments of which the following description gives examples.

### BRIEF DESCRIPTION OF THE DRAWINGS

The invention will now be described with reference to the Figures in which:

FIG. 1 shows the nitrogen cycle in pasture.

FIG. 2 shows cumulative emissions from a control and urine treatments with and

without DCD, a high concentration albendazole sulfoxide (ALBSO) composition, a low concentration ALBSO composition and a carrier composition. Data points represent mean values (n=5).

FIG. 3 shows a reshaped chemical drum for constructing a lysimeter.

FIG. 4 shows a PVC tube inserted in reshaped chemical drum for constructing a lysimeter (soil not shown).

FIG. 5 shows the amount of NO₃ leached from soil after application of urine with and without ALBSO or DMPP.

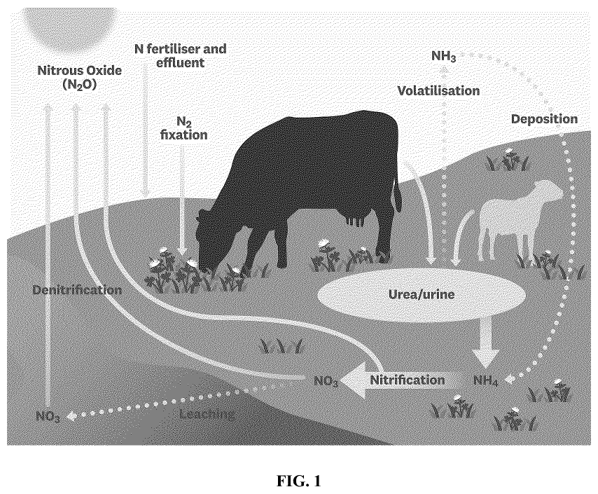

### DETAILED DESCRIPTION OF THE INVENTION

The present inventors have surprisingly discovered that certain bicyclic 1H-benzo[d]imidazol-2-yl ester compounds have nitrogen oxide scavenging activity. These compounds may be useful for reducing nitrous oxide (N₂O) emissions and/or reducing nitrate (NO₃) leaching, from a nitrogen containing substrate, e.g., from soil.

The bicyclic 1H-benzo[d]imidazol-2-yl ester compound of the invention is a compound of formula (I):

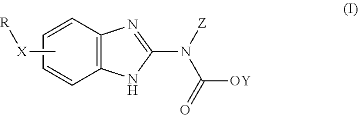

wherein R is selected from the group consisting of C₁₋₅ alkyl, C₂₋₅ alkenyl and C₃₋₅ cycloalkyl; X is selected from the group consisting of CH₂, CO, SO and SO₂; Z is selected from the group consisting of H, C₁₋₅ alkyl, C₂₋₅ alkenyl and C₃₋₅ cycloalkyl; and Y is selected from the group consisting of C₁₋₅ alkyl, C₂₋₅ alkenyl and C₃₋₅ cycloalkyl. Preferably, is C₁₋₅ alkyl. In some embodiments, R is selected from the group consisting of methyl, ethyl, propyl, butyl and pentyl. Preferably, R is propyl. Preferably, X is SO. Preferably, Z is H. Preferably, Y is C₁₋₅ alkyl. In some embodiments, Y is selected from the group consisting of methyl, ethyl, propyl, butyl and pentyl. Preferably, Y is methyl.

In some embodiments, the bicyclic 1H-benzo[d]imidazol-2-yl ester compound is a compound of formula (Ia):

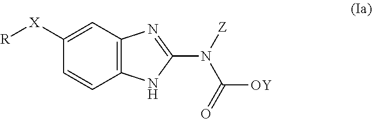

wherein R is selected from the group consisting of C₁₋₅ alkyl, C₂₋₅ alkenyl and C₃₋₅ cycloalkyl; X is selected from the group consisting of CH₂, CO, S, SO and SO₂; Z is selected from the group consisting of H, C₁₋₅ alkyl, C₂₋₅ alkenyl and C₃₋₅ cycloalkyl; and Y is selected from the group consisting of C₁₋₅ alkyl, C₂₋₅ alkenyl and C₃₋₅ cycloalkyl. Preferably, is C₁₋₅ alkyl. In some embodiments, R is selected from the group consisting of methyl, ethyl, propyl and pentyl. Preferably, R is propyl. Preferably, X is SO. Preferably, Z is H. Preferably, Y is C₁₋₅ alkyl. In some embodiments, Y is selected from the group consisting of methyl, ethyl, propyl and pentyl. Preferably, Y is methyl.

Preferably, the bicyclic 1H-benzo[d]imidazol-2-yl ester compound is albendazole sulfoxide(methyl [5-(propane-1-sulfinyl)-1H-benzoimidazol-2-yl]-carbamate; ALBSO).

The bicyclic 1H-benzo[d]imidazol-2-yl ester compound of the invention may be useful for reducing N₂O emissions from a nitrogen containing substrate. N₂O emissions from a nitrogen containing substrate may be reduced when treated with a compound of the invention compared with a nitrogen containing substrate that has not been treated. In some embodiments, the compound of the invention may reduce N₂O emissions by at least about 15%, or at least about 20%, or at least about 25%, or at least about 30% compared with an untreated nitrogen containing substrate.

The nitrogen containing substrate can be bare soil or can be a soil that is covered by plants/grass, i.e. productive arable or pasture land.

The bicyclic 1H-benzo[d]imidazol-2-yl ester compound of the invention may be useful for reducing NO₃ leaching from a nitrogen containing substrate, e.g. soil.

Without wishing to be bound by theory, it is believed the bicyclic 1H-benzo[d]imidazol-2-yl ester compound may reduce N₂O emissions and/or reduce NO₃ leaching by blocking the pathway that produces the nitrous oxide catalysing enzyme ammonia monooxygenase.

Nitrogen may be introduced into soil, e.g. as an animal waste or fertiliser, in the form of urea, which is subsequently converted to ammonium. Alternatively, nitrogen may be introduced into soil in the form of an ammonium, e.g. as a fertiliser. Ammonium may be transformed into NO₃ and a small amount of N₂O by micro-organisms called nitrifers in a process known as nitrification. In another process, NO₃ may be transformed into N₂O by micro-organisms called denitrifiers in a process known as denitrification. Without wishing to be bound by theory, it is believed the bicyclic 1H-benzo[d]imidazol-2-yl ester compound of the invention may reduce N₂O emissions and/or NO₃ leaching by inhibiting the nitrification and/or denitrification process.

The bicyclic 1H-benzo[d]imidazol-2-yl ester compound may be formulated in a liquid agricultural composition comprising a suitable liquid agriculturally acceptable carrier. The agricultural composition may be a solution suitable for spray application.

The agriculturally acceptable carrier may comprise a solvent and a weak acid. Preferably, the solvent is water. The weak acid may be an acid having a pH between about 2 and about 7, or between about 3 and about 6. The weak acid may be an organic acid or a mineral acid. In some embodiments, the weak acid is an organic acid, such as a carboxylic acid. Preferably, the carboxylic acid is formic acid. In some embodiments, the weak acid is a mineral acid. Preferably, the mineral acid is boric acid. Advantageously, the weak acid may contribute to nitrogen scavenging activity. For example, the weak acid may modulate nitrification, denitrification and/or urease activity.

The agricultural composition may comprise a weak acid in a concentration of about 0.04 M to about 0.06 M. In some embodiments, the agricultural composition may comprise a weak acid in a concentration of about 0.05 M. The agricultural composition may comprise, e.g., about 1.9 mL weak acid L⁻¹. Preferably, the agricultural composition comprises the minimum amount of the weak acid required to dissolve the bicyclic 1H-benzo[d]imidazol-2-yl ester compound. In some embodiments, the agricultural composition comprises a weak acid in a concentration of about 0.05 M. In some embodiments, the carrier comprises a weak acid and water in a ratio of about 1:533 v/v. Preferably, the pH of the agricultural composition is mildly acid or close to neutral. In some embodiments, the pH of the agricultural composition is about 4 to about 7.

Other agriculturally acceptable carriers may be useful in the invention. Those persons skilled in the art may select a suitable carrier based on the intended application, e.g. a carrier that is capable of substantially dissolving the bicyclic 1H-benzo[d]imidazol-2-yl ester compound and/or is non-toxic for agricultural use.

The agricultural composition may comprise the bicyclic 1H-benzo[d]imidazol-2-yl ester compound in an amount of about 5.3 to about 18 mgL⁻¹.

The agricultural composition may be manufactured by dissolving the bicyclic 1H-benzo[d]imidazol-2-yl ester compound in a liquid agricultural acceptable carrier. In some embodiments, the agricultural composition is prepared by a method comprising
i) dissolving the bicyclic 1H-benzo[d]imidazol-2-yl ester compound in a solution comprising a weak acid and a solvent (1:9 v/v),
ii) adding a concentrated weak acid to the solution from step (i), and
iii) diluting the resulting solution from step (ii) with a solvent to achieve the desired concentration.

In some embodiments, the agricultural composition is prepared by a method comprising
i) dissolving the bicyclic 1H-benzo[d]imidazol-2-yl ester compound in a solution comprising a weak acid and water (1:9 v/v),
ii) adding a concentrated weak acid to the solution from step (i), and
iii) diluting the resulting solution from step (ii) with water to achieve the desired concentration.

The agricultural composition of the present invention can be prepared as a ready to use liquid formulation or can be prepared as a concentrated formulation that can be further diluted with a suitable solvent prior to application to a nitrogen containing substrate.

In one aspect, the present invention provides a method of reducing N₂O emissions and/or NO₃ leaching from a nitrogen containing substrate, preferably from soil, the method comprising applying a liquid agricultural composition of the invention to the substrate. The agricultural composition may be applied directly to the substrate. The agricultural composition may also be applied indirectly to the substrate, e.g. to a plant or plant part in or proximate to the substrate.

The source of nitrogen in the nitrogen containing substrate may be, e.g., at least one animal waste and/or at least one nitrogenous fertiliser. In some embodiments, the nitrogen source may be an animal waste. The animal waste may be excreta, such as faeces or urine, from an animal. The animal may be a grazing animal selected from the group consisting of cattle, a sheep, a goat and/or a horse. Those skilled in the art, however, will appreciate that the invention may be useful for treating a substrate, e.g. soil or pasture, contacted by excreta from other animals. In some embodiments, the nitrogen source is a nitrogenous fertiliser. In some embodiments, the nitrogen source is a combination of one or more animal wastes and/or one or more nitrogenous fertilisers.

The invention may be useful for reducing N₂O emissions and/or NO₃ leaching in any nitrogen containing substrate, in particular in a soil environment where the soil environment contains a nitrogen source. Examples of suitable soils include, but are not limited to, pasture soil and arable soil. The soil environment contains nitrogen in an amount greater that 0 kg N ha⁻¹, e.g., an amount greater than about 25 kg N ha⁻¹, or greater than about 50 kg N ha⁻¹, or greater than about 100 kg N ha⁻¹, or greater than about 200 kg N ha⁻¹, or greater than about 300 kg N ha⁻¹, or greater than about 400 kg N ha⁻¹, or greater than about 500 kg N ha⁻¹, or greater than about 600 kg N ha⁻¹, or greater than about 700 kg N ha⁻¹, or greater than about 800 kg N ha⁻¹, or greater than about 900 kg N ha⁻¹, or greater than about 1000 kg N ha⁻¹, or greater than about 1100 kg N ha⁻¹. For example, the soil may be a urine patch with a nitrogen load greater than about 200 kg N ha⁻¹, such as about 200 to about 1200 kg N ha⁻¹.

The agricultural composition may be applied to the bare soil or to a plant covered arable or pasture soil before, during or after the soil is contacted with an exogenous nitrogen source. In some embodiments, the agricultural composition is applied to the soil environment before, during or after the soil is contacted with at least one animal waste, e.g., from a grazing animal. For example, the agricultural composition may be applied to pasture soil after the soil is contacted with urine, e.g. from a grazing animal. In some embodiments, the agricultural composition is applied to arable soil before, during or after the soil is contacted with at least one nitrogenous fertiliser.

The agricultural composition may also be used to clean up nitrogen contaminated pasture or arable soils.

When used for reducing N₂O emissions and/or NO₃ leaching, the agricultural composition is applied to a soil environment to at least partially cover an area of soil, e.g. a pasture or an arable field. In some embodiments, the agricultural composition may be applied to the soil environment to cover substantially all of an area of soil. Alternatively, application of the agricultural composition may be targeted to specific areas, e.g. areas that have or are expected to have a higher nitrogen load. For example, application of the agricultural composition may be targeted to urine patches in the soil environment.

The agricultural composition may be applied to a soil environment by spraying, e.g., with a manual sprayer or with an automated system. Automated systems may include systems configured to detect areas with a high nitrogen load and apply the agricultural composition to those areas. For example, the automated system may be a spot-sprayer system that detects, and applies the agricultural composition to, urine patches on the surface of the soil environment (such as the Spikey® supplied by Pasture Robotics Limited).

The agricultural composition may be applied to the substrate at a rate of, e.g., above 0 kg N ha⁻¹ to about 400 kg N ha⁻¹. In some embodiments, the application rate is about 200 kg N ha⁻¹ to about 400 kg N ha⁻¹. In some embodiments, the application rate is about 200 kg N ha⁻¹. In some embodiments, the application rate is about 400 kg N ha⁻¹. In some embodiments, the agricultural composition may be applied to the substrate at a rate that delivers the bicyclic 1H-benzo[d]imidazol-2-yl ester compound in an amount of about 50 to about 750 ng mL⁻¹ urine, about 100 to about 700 ng mL⁻¹ urine or about 133 to about 450 ng mL⁻¹ urine.

In another aspect, the bicyclic 1H-benzo[d]imidazol-2-yl ester compound may be formulated in a liquid concentrate composition comprising a suitable agriculturally acceptable carrier. Such a formulation may be convenient for storage and/or transport. The concentrate formulation may be diluted with a suitable solvent prior to use.

Also contemplated is a nitrogenous fertilised coated with the bicyclic 1H-benzo[d]imidazol-2-yl ester compound. For example, a granular urea or nitrate fertiliser at least partially coated with a coating comprising the bicyclic 1H-benzo[d]imidazol-2-yl ester compound. The coated nitrogenous fertiliser may be applied to, or proximate to, soil, e.g. arable soil, to reduced N₂O emissions and/or NO₃ leaching compared to an uncoated nitrogenous fertiliser.

The following non-limiting examples are provided to illustrate the present invention and in no way limit the scope thereof.

### EXAMPLES

### Example 1—Reduction of N₂O Emissions

### Methods and Materials

A trial site was fenced off and stock excluded for about 14 weeks, until the commencement of the field trials, to avoid interference from fresh dung and urine inputs and reduce spatial heterogeneity/variability from the previous uneven deposition of dung and urine.

Approximately two weeks before the commencement of the trial, pasture was mown to 50 mm height, 4 soil samples (to 100 mm depth) were collected for physicochemical characterisation and Field plots were established in a randomised complete block design with 5 treatments as shown in Table 1. Plot size was 2.5×2.5 m for all treatments with an additional buffer area of at least 0.5 m between adjacent plots.

TABLE 1

| Treatment | Urine amount | N₂O inhibitor composition |
|---|---|---|
| Control | — | — |
| Urine | 2 L − 16.70 g N | — |
| Urine + DCD | 2 L − 16.70 g N | DCD (0.25 g N) |
| (UDCD) | | |
| Urine + high | 2 L − 16.70 g N | 900 μg ALBSO (57 μg N) in 0.054M |
| concentration | | formic acid |
| ALBSO (UA1) | | |
| Urine + low | 2 L − 16.70 g N | 266 μg ALBSO (18 μg N) in 0.054M |
| concentration | | formic acid |
| ALBSO (UA2) | | |
| Urine + carrier | 2 L − 16.70 g N | 0.054M formic acid |
| (UC) | | |

### Application of Urine and Inhibitors

Natural urine deposition was simulated with 2 L cattle urine (containing 8.35 g N L⁻¹) in large static chambers allowing for urine edge-effect. All solutions containing a N₂O inhibitor were applied at the same rate (30 mL/Chambers; 600 L/ha). For all urine treatments, 2 L urine was poured to the central point of the chamber base area at a height of approximately 1.2 m and allowed to spread naturally. To mimic the “Spikey®” urine patch treatment, a spot-sprayer system (supplied by Pastoral Robotics Limited) was used for treating the urine patch in the large chambers. All the inhibitor compositions were applied to the relevant treatments within 4 h after urine application.

### Nitrous Oxide Measurement

A static chamber technique was used to measure N₂O emissions, and the methodology was based on that used in a previous published study on N₂O emissions (Luo et al 2015). One week before the trial began, static chamber bases (80 cm diameter) were inserted into the soil. Herbage within the chamber base and the ring areas was cut to 50 mm above ground level before the application of the treatments.

Pre-treatment gas flux was taken from each chamber a day before the application of treatments to determine the spatial variability of background of N₂O flux between the plots and to assist with interpretation of patterns of N₂O flux from individual sampling plots post treatment application as a covariate for statistical analysis of post-treatment emissions.

Post treatment gas measurements were carried out at 2, 24 and 72 h after application of the urine and inhibitor compositions, twice a week for the first 8 weeks and thereafter weekly. The measurements were continued until the N₂O flux values for treatment plots reached the background levels measured in the control plots. During weekly phases of N₂O flux measurement, additional sampling occurred as soon as practical following rainfall events of greater than 10 mm of rain in the previous 24 h. On each sampling day, N₂O measurements were carried out between 1000 and 1200 h. Gas samples from chamber headspace were taken during a cover period of 100 minutes at times t0, t30 and t60 (or similar). Two background atmosphere samples were also taken on each sampling day at each site. The autumn/winter rains and mild temperature in the region resulted in continued higher emissions from the treatment plots. The measurements of N₂O emission from the treatment plots continued until the first week of September. During this period, 3 pasture harvests were taken, and herbage samples analysed for N content.

Nitrous oxide concentration of gas samples were analysed by gas chromatograph using a Shimadzu GC-17a gas chromatograph equipped with a 63Ni-electroncapture detector (oven, valve and detector temperatures were operated at 65, 100 and 280° C., respectively, using oxygen-free N as a carrier gas and connected to an automatic sampler capable of handling up to 120 samples, and a SRI 8610 automated gas chromatograph. Chamber temperatures were recorded at the beginning and end of the cover period and the average of the two readings were considered the chamber temperature for calculating gas flux. The increase in N₂O concentration within the chamber headspace, for the gas samples collected at t0, t50 and t100 was generally linear (R2>0.90). Therefore, the hourly N₂O fluxes will be calculated using linear regression and the ideal gas law according to Equation 1:

$$F = \frac{δ {N}_{2} O}{δ T} \times \frac{M}{{V}_{m}} \times H \qquad ( 1 )$$

where, F is the hourly N₂O fluxes (mg N m⁻² h⁻¹); δN₂O is the increase in head space N₂O over time (μL L⁻¹); δT is the enclosure period (hours); M is the molar weight of N in N₂O; Vₘ is the molar volume of gas at the sampling temperature (L mol⁻¹); H is the height of headspace (m).

The detection limit of N₂O concentration is 14.9±1.1 ppbv N₂O and the 95% confidence interval for flux detection is approximately 12 μg N₂O m⁻² h⁻¹ for a chamber (150 mm height) under standard conditions of temperature and pressure. For each chamber, the hourly flux data was integrated over via trapezoidal integration of the linear flux on measurement dates to estimate the total emissions over the measurement period.

Emission factors (EF₃, N₂O—N emitted as % of urine N applied) for urine and inhibitor treatments were calculated following the IPCC (2006) methodology, using Equation 2:

$${EF}_{s} = \frac{{N}_{2} {O}_{urine} - {N}_{2} {O}_{control}}{urine N applied} \times 100 \% \qquad ( 2 )$$

where, EF₃ is emission factor (N₂O—N emitted as % of urine-N applied), N₂Oᵤᵣᵢₙₑ and N₂O_{control} are the cumulative N₂O—N emissions from the urine (with or without inhibitors) and control plots, respectively (kg N ha⁻¹), and urine N applied is the rate of urine N (kg N ha⁻¹) to treatment chambers.

### Net Herbage Accumulation

Herbage growing within the pasture sampling rings was cut to approximately 50 mm above ground level when a target herbage height of approximately 150 mm was reached (about 4 to 6-week intervals) over the spring period. Cut herbage was removed, weighed and a subsample dried at 70° C. for 24 to 48 h (until no further change in herbage weight) to determine dry matter (DM) content. All the cutting from each sampling chamber were combined and a subsample dried, ground and analysed for N content on an organic N elemental combustion instrument (LECO Australia Pty Ltd).

### Environmental Conditions

Daily rainfall and ambient air and soil temperatures were recorded for the entire trial period, beginning at least 1 week before treatment application, at a site as close as possible to the trial site. A manual rain gauge was also installed at the site to determine total rainfall between sampling days.

### Results

The N₂O fluxes from all the plots a day before the application of the treatment ranged between 2.6 and 3.4 g N₂O—N ha⁻¹ were very low and did not vary among the plots.

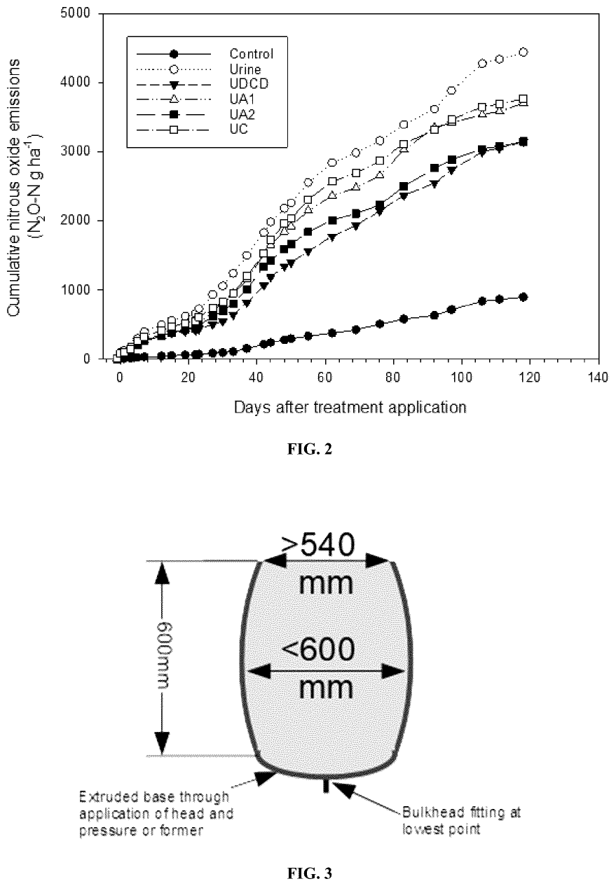

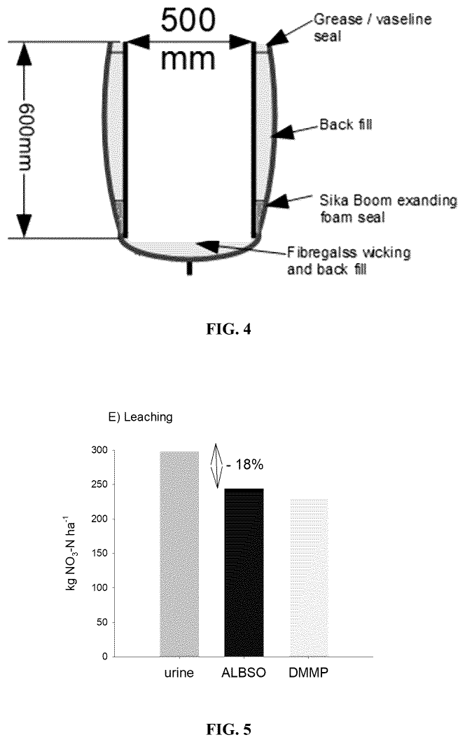

The cumulative N₂O emissions from all treatments are shown in FIG. 2. N₂O emissions from the control and water only treatments during the 4-month measurement period were similar (896±136 and 1008±106 g N₂O—N ha⁻¹). Therefore, only emissions from the control treatment are plotted and used in the calculations of emission factors (EFs) and reduction in emissions.

The calculated N₂O EFs and changes in emissions based on the cumulative emissions data are shown in Table 2.

TABLE 2

| | Total | | | EF₃ | Emissions |
|---|---|---|---|---|---|
| | emitted | Net emitted | Applied total N | (% of applied | Reduction |
| Treatment | (g N₂O—N) | (g N₂O—N) | (Kg N) | N emitted) | (%) |
| Control | 896 | 896 | 0 | — | — |
| Urine | 4440 | 3544 | 331.60 | 1.07 | 0 |
| Urine + DCD | 3142 | 2246 | 337.17 | 0.67 | −38 |
| (UDCD) | | | | | |
| Urine + high | 3703 | 2807 | 333.33 | 0.84 | −21 |
| concentration | | | | | |
| ALBSO (UA1) | | | | | |
| Urine + low | 3147 | 2251 | 332.56 | 0.68 | −37 |
| concentration | | | | | |
| ALBSO (UA2) | | | | | |
| Urine + carrier | 3765 | 2869 | 332.20 | 0.86 | −19 |
| (UC) | | | | | |

The results show that application of urine resulted in net emissions of 3544 g N₂O—N ha⁻¹ (EF₃=1.07) and addition of DCD and the low concentration ALBSO composition to urine reduced N₂O by 38% and 37%, respectively (EF₃=0.67 and 0.68). The emissions reduction from urine obtained with the addition of the high concentration ALBSO composition and the carrier composition were lower (21% and 19%) with higher EF₃ values of 0.84 and 0.86, respectively, than obtained with DCD and the low concentration ALBSO composition.

Advantageously, emissions from urine treated with the low concentration ALBSO composition (3147 g N₂O—N ha⁻¹) were comparable to the emissions from urine treated with DCD (3142±300 g N₂O—N ha⁻¹).

The data on net herbage accumulation (NHA) from all the treatments of the 3 harvests taken during the 4-month (May-September) trial period are presented in Table 3. Table 3 shows the effect on NHA production from urine-N added to pasture soil with and without inhibitors. Data present mean values±standard error of mean (n=5). Means followed by different lowercase letters in a column are significantly different (P<0.05). Overall, in this mild autumn-winter trial there was no urine-N response or DCD effect on NHA. This could be attributed to limited growth of pasture species particularly ryegrass at low temperatures and wetter soil moisture conditions.

TABLE 3
Net herbage accumulation (kg ha⁻¹)

| Treatments | 1^{st} harvest | 2^{nd} harvest | 3^{rd} harvest |
|---|---|---|---|
| Control | 283 ± 60^{a} | 511 ± 81^{a} | 454 ± 31^{a} |
| Urine | 375 ± 56^{a} | 545 ± 99^{a} | 673 ± 126^{a} |
| Urine + DCD | 413 ± 103^{a} | 578 ± 95^{a} | 524 ± 54^{a} |
| (UDCD) | | | |
| Urine + high | 384 ± 52^{a} | 492 ± 69^{a} | 545 ± 87^{a} |
| concentration | | | |
| ALBSO (UA1) | | | |
| Urine + low | 380 ± 87^{a} | 470 ± 124^{a} | 561 ± 113^{a} |
| concentration | | | |
| ALBSO (UA2) | | | |
| Urine + carrier (UC) | 325 ± 56^{a} | 587 ± 43^{a} | 647 ± 80^{a} |

### CONCLUSION

In conclusion, a low concentration ALBSO composition was equally effective as the New Zealand standard DCD in mitigating N₂O emissions from simulated urine cattle patches. This field evaluation demonstrates that bicyclic 1H-benzo[d]imidazol-2-yl ester compounds have the potential to be a suitable inhibitor for reducing N₂O emissions from urine deposited in livestock grazed pasture soils.

### Example 2—Denitrification Experiments

### Materials and Methods

Short-term incubation studies were conducted to determine the effect of the compound of the invention on soil potential denitrification (DEA) enzyme activity. Details of each assay are described in Zhong et al. (2015, 2016).

The denitrification assay involved testing the effect of five ALBSO treatments: 0 (water only), carrier (formic acid only), low (0.011 μg ALBSO g⁻¹ dry soil), high (0.046 μg ALBSO g⁻¹ dry soil) and very high (0.91 μg ALBSO g⁻¹ dry soil) at a common N rate delivered as KNO₃.

The ALBSO treatments were formulated with an absolute minimum amount of formic acid needed to just dissolve the required amount of ALBSO into solution. Identical amounts of formic acid were used to formulate the carrier, low, high and very high ALBSO treatments, with the carrier containing only formic acid and water. The pH of carrier, low, high and very high ALBSO treatment solutions was identical and mildly acidic.

### Denitrification Enzyme Activity (DEA)

After a 4-hour incubation period, N₂O concentrations were lower (P<0.008) for incubation vessels that had been treated with ALBSO. The absolute amount of ALBSO added did not make a difference to the rate of N₂O formation (Table 4). However, after an 8-hour incubation period the concentration of N₂O was similar for all treatments (P=0.97) (Table 4), indicating a time limit to the effectiveness of ALBSO under conditions present within the incubation vessels (28° C., anaerobic and supplemented with glutamic acid and glucose) and/or an N resource limitation. Typically, results for this kind of incubation become unreliable after 6 hours, however, the 8 hour sampling in case the high level of N addition allowed for a longer period of microbial activity.

TABLE 4

| | ppm N₂O after 4 h | | ppm N₂O after 8 h | |
|---|---|---|---|---|
| ALBSO treatment | Mean (n = 3) | LSD = 26 | Mean | LSD = 98 |
| H₂O | 138 | b | 236 | |
| Low | 96 | a | 233 | |
| High | 102 | a | 217 | |
| Very High | 86 | a | 232 | |

A further incubation was performed to test the effect of the carrier as well as the high rate of ALBSO on denitrification enzyme activity. A non-significant reduction in N₂O from using the carrier was seen at 4 hours but not at 8 hours (Table 5).

TABLE 5

| ALBSO | ppm N₂O after 4 h | | ppm N₂O after 8 h | |
|---|---|---|---|---|
| treatment | Mean (n = 4) | LSD = 22 | Mean (n = 4) | LSD = 11 |
| H₂O | 97 | | 137 | |
| Carrier | 91 | | 143 | |
| High | 90 | | 131 | |

The final incubation included a treatment where acetylene was not added. The use of acetylene gives further information on whether the ALBSO effect on denitrification is due to effects on enzymes linked to nirK and nirS (with acetylene) or nosZ (without acetylene) genes. There was a significant effect of ALBSO on reducing N₂O over both acetylene treatments (P=0.005) but identification of the genes being affected was inconclusive. Table 6 shows the effect of ALBSO on N₂O concentration (ppm N₂O) in the incubation vessels after a 4-hour incubation period and when acetylene was added or not added. Letters refer to ALBSO effects within acetylene treatments (LSD 5.3, n=3).

TABLE 6

Acetylene

| ALBSO treatment | No | Yes |
|---|---|---|
| H₂O | 97.3b | 96.9b |
| High | 84.7a | 90.9a |

These experimental results show there was a clear influence of ALBSO in reducing N₂O emissions.

### Example 3—Nitrate Leaching

A field lysimeter study was conducted to examine the effects of albendazole sulfoxide on NO₃⁻ leaching resulting from cow urine applied to a grazed pasture (at a loading rate of about 600 kg N ha⁻¹). The field lysimeter experiment was a randomized complete block design with the following treatments:
Control (no urine and no inhibitor)
Urine alone (600 kg N ha⁻¹)
Urine plus DCD (DCD solution at 10 kg ha⁻¹)
Urine plus albendazole sulfoxide (supplied by AgResearch Palmerston North)

Urine was collected from dairy cows that had been grazing an established ryegrass-white clover pasture. The cow urine was bulked and held at 4° C. for a few days prior to application. The urine was applied in a single application at an N loading rate of 600 kg N ha⁻¹ and a hydraulic loading rate of 10 L m⁻² to simulate dairy cow urine deposition. DCD and albendazole sulfoxide (supplied by AgResearch Palmerston North) were dissolved into solution at concentrations that resulted in hydraulic application rates of 1 L m⁻², applied within 1 hour following urine application. The treatments were replicated 6 times.

These urine and inhibitor treatments were also simultaneously applied to associated 0.5 m² plots so that soil samples could be taken throughout the trial to monitor mineral N transformations and moisture levels.

Leachate volumes were measured from the lysimeters when drainage occurred over the drainage period (May-October). Subsamples of leachate were collected and frozen at −20° C. prior to analysis for nitrate N(NO₃⁻N) and ammonium N(NH₄⁺—N) using a Skalar SAN⁺⁺ segmented auto flow analyser (Skalar Analytical B.V., Breda, Netherlands).

Inorganic-N was leached predominantly as NO₃⁻—N, with little NH₄⁺—N leached (data not shown). Peak NO₃⁻—N concentrations, reaching 110 mg NO₃⁻—NL⁻¹, appeared about one month after urine application. Total NO₃⁻ loads in drainage from application of cow urine confirm the large N leaching risk from urine patches deposited in late autumn/winter, with up to 60% of the deposited urine-N leached from the tested Te Kowhai soil. Consequently, there is a need to target mitigations at either retaining this deposited N in the soil profile or removing the source by removing the stock.

There was a significant inhibition effect (P<0.05) after 37 days of treatment application, with less NO₃⁻—N leached from the inhibitor treatments than from the urine treatment (Table 7). Application of DCD and albendazole sulfoxide significantly decreased total NO₃⁻—N leaching (P<0.05) by 30% and 20%, respectively, compared to the urine only treatment. The difference in the effectiveness of the two inhibitors was not significant (P>0.05), although the performances of both albendazole sulfoxide appeared to be inferior to that of DCD. It might be expected that increasing the albendazole sulfoxide application rates, therefore increasing their levels in the soil, would increase their effectiveness.

TABLE 7
Total nitrate leaching from cow urine treatments
with nitrification inhibitors applied.

| | Total leaching | % Reduction of leaching |
|---|---|---|
| Treatment | (kg NO₃⁻—N ha⁻¹) | due to inhibitor |
| Control | 2 | |
| Urine | 358 | |
| Urine + DCD | 253 | 30* |
| Urine + albendazole | 289 | |
| sulfoxide | | 20* |

*indicates statistical significance at P < 0.05

It is noted, the effectiveness of DCD and albendazole sulfoxide may have been affected by above average rainfall and temperatures during the study period. The average soil temperature for the measurement period was 1.5° C. higher than the 10-year average for the same period. It is expected that the inhibition effectiveness of albendazole sulfoxide would have been greater under more “favourable” conditions.

### CONCLUSION

The above results demonstrate that the compound of formula (I) is an effective inhibitor of N₂O emissions and NO₃ leaching. Consequently, the compound of formula (I) can be useful to mitigate the environmental impact of these greenhouse gases, e.g. resulting from livestock deposited urine, and to assist in achieving greenhouse gas reduction targets across the agricultural sector.

It is not the intention to limit the scope of the invention to the abovementioned examples only. As would be appreciated by a skilled person in the art, many variations are possible without departing from the scope of the invention as set out in the accompanying claims.

### REFERENCES

The entire content of each of the following documents is incorporated herein by reference:
Luo et al. Biol Fertil Soils (2015) 51, 453-464
Zhong et al. Geoderma (2015) 259-260, 62-70
Zhong et al. Agric Ecosyst Environ (2016) 217, 70-78.

1. Use of a compound of formula (I): 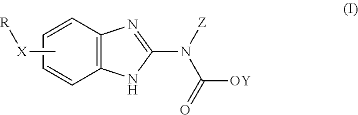
wherein R is C₁₋₅ alkyl, C₂₋₅ alkenyl or C₃₋₅ cycloalkyl;
X is CH₂, CO, S, SO or SO₂;
Z is H, C₁₋₅ alkyl, C₂₋₅ alkenyl or C₃₋₅ cycloalkyl; and
Y is C₁₋₅ alkyl, C₂₋₅ alkenyl or C₃₋₅ cycloalkyl;
for reducing N₂O emissions and/or NO₃ leaching from a nitrogen containing substrate.

2. Use of claim 1, wherein the nitrogen containing substrate is a pasture or an arable soil.

3. Use of claim 1 or 2, wherein the compound is a compound of formula (Ia):

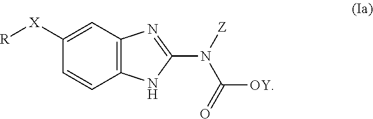

4. Use of any one of claims 1 to 3, wherein R is C₁₋₅ alkyl; X is SO; Z is H; and Y is C₁₋₅ alkyl.

5. Use of claim 1 or 2, wherein the compound is albendazole sulfoxide.

6. A liquid agricultural composition for reducing N₂O emissions and/or NO₃ leaching from a nitrogen containing substrate, the composition comprising:
a) a compound of formula (I): 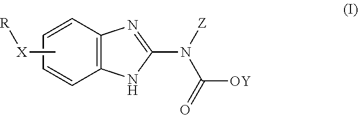
wherein R is C₁₋₅ alkyl, C₂₋₅ alkenyl or C₃₋₅ cycloalkyl;
X is CH₂, CO, S, SO or SO₂;
Z is H, C₁₋₅ alkyl, C₂₋₅ alkenyl or C₃₋₅ cycloalkyl; and
Y is C₁₋₅ alkyl, C₂₋₅ alkenyl or C₃₋₅ cycloalkyl; and
b) a liquid agriculturally acceptable carrier.

7. The liquid agricultural composition of claim 6, wherein the compound is a compound of formula (Ia):

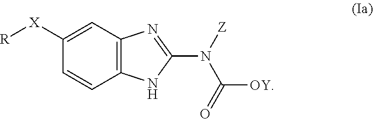

8. The liquid agricultural composition of claim 6 or 7, wherein R is C₁₋₅ alkyl; X is SO; Z is H; and Y is C₁₋₅ alkyl.

9. The liquid agricultural composition of claim 6, wherein the compound is albendazole sulfoxide.

10. The liquid composition of any one of claims 6 to 9, wherein the liquid agriculturally acceptable carrier comprises a solvent and a weak acid.

11. The liquid composition of claim 10, wherein the solvent is water.

12. The liquid composition of claim 10 or 11, wherein the weak acid is formic acid.

13. The liquid composition of any one of claims 6 to 12, wherein the composition comprises the compound in a concentration of about 5.3 to about 18 mg L⁻¹.

14. The liquid composition of any one of claims 6 to 13, comprising albendazole sulfoxide, formic acid and water.

15. The liquid composition of any one of claims 6 to 14, wherein the nitrogen containing substrate is a pasture or an arable soil.

16. A method of reducing N₂O emissions and/or NO₃ leaching from a nitrogen containing substrate, the method comprising applying a composition of any one of claims 6 to 16 to the substrate, wherein the composition is applied to the substrate before, during or after the substrate is contacted with a nitrogen source selected from the group consisting of an animal waste, a nitrogenous fertiliser and a combination thereof.

17. A method of claim 16, wherein the nitrogen containing substrate is a pasture or an arable soil.

18. The method of claim 17, wherein the composition is applied to substantially all of the pasture or arable soil.

19. The method of claim 17, wherein the composition is spot applied to areas of high nitrogen load in the pasture or arable soil.

20. The method of any one of claims 16 to 19, wherein the composition is applied with a manual sprayer or an automated sprayer system.

21. The method of any one of claims 16 to 20, wherein the animal waste is urine from a grazing animal.

22. The method of any one of claims 16 to 21, wherein the composition is applied to the substrate at a rate of above 0 kg N ha⁻¹ to about 400 kg N ha⁻¹.

23. A coated fertiliser composition comprising a nitrogenous fertiliser at least partially coated with a compound of formula (I): 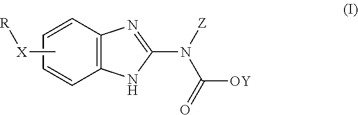
wherein R is C₁₋₅ alkyl, C₂₋₅ alkenyl or C₃₋₅ cycloalkyl;
X is CH₂, CO, S, SO or SO₂;
Z is H, C₁₋₅ alkyl, C₂₋₅ alkenyl or C₃₋₅ cycloalkyl; and
Y is C₁₋₅ alkyl, C₂₋₅ alkenyl or C₃₋₅ cycloalkyl.

24. Use of a compound of formula (I): 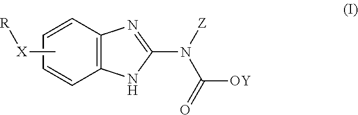
wherein R is C₁₋₅ alkyl, C₂₋₅ alkenyl or C₃₋₅ cycloalkyl;
X is CH₂, CO, S, SO or SO₂;
Z is H, C₁₋₅ alkyl, C₂₋₅ alkenyl or C₃₋₅ cycloalkyl; and
Y is C₁₋₅ alkyl, C₂₋₅ alkenyl or C₃₋₅ cycloalkyl in the manufacture of an agricultural composition for reducing N₂O emissions and/or NO₃ leaching from a nitrogen containing substrate.

25. Use of claim 24, wherein the nitrogen containing substrate is a pasture or an arable soil.

26. A method of manufacturing an agricultural composition comprising dissolving a compound of formula (I): 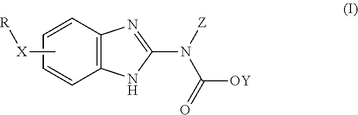
wherein R is C₁₋₅ alkyl, C₂₋₅ alkenyl or C₃₋₅ cycloalkyl;
X is CH₂, CO, S, SO or SO₂;
Z is H, C₁₋₅ alkyl, C₂₋₅ alkenyl or C₃₋₅ cycloalkyl; and
Y is C₁₋₅ alkyl, C₂₋₅ alkenyl or C₃₋₅ cycloalkyl;
in a liquid agricultural acceptable carrier.

27. A concentrated liquid composition comprising a compound of formula (I): 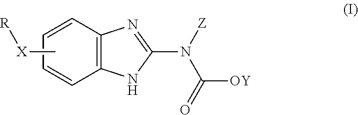
wherein R is C₁₋₅ alkyl, C₂₋₅ alkenyl or C₃₋₅ cycloalkyl;
X is CH₂, CO, S, SO or SO₂;
Z is H, C₁₋₅ alkyl, C₂₋₅ alkenyl or C₃₋₅ cycloalkyl; and
Y is C₁₋₅ alkyl, C₂₋₅ alkenyl or C₃₋₅ cycloalkyl; and
a liquid agricultural acceptable carrier.
